(19) United States
(12) Patent Application Publication
(10) Pub. No.: US 2011/0059757 A1
(43) Pub. Date: Mar. 10, 2011

(54) SYSTEMS AND METHODS FOR AUTOMATIC DELIVERY OF 411 CALLER INFORMATION

(75) Inventor: Mark Gosselin, Seattle, WA (US)

(73) Assignee: Cequint, Inc., Seattle, WA (US)

(21) Appl. No.: 12/555,719

(22) Filed: Sep. 8, 2009

(51) Int. Cl. H04W 4/12; H04M 11/00

(52) U.S. Cl. 455/466; 455/403

(57) ABSTRACT

A client application on a mobile handset that identifies a short message service (SMS) messages in a 411 format and extracts the caller identification information in the SMS message. The client application presents a query on the display or keypad of the mobile handset that allows the subscriber to automatically enter the extracted caller identification information into the contacts or caller information directory on the mobile device.

### FIELD OF THE INVENTION

This invention relates generally to 411 calls and, more specifically, to automatic delivery of 411 caller information.

### BACKGROUND OF THE INVENTION

When a 411 operator or Directory Assistance (DA) is dialed on a wireless handset, carriers or their 411 service providers (DAs) can optionally provide a short message service (SMS) message to the mobile handset over the network from the operator's station containing the requested caller information, mapping information, etc. to supplement the expected oral delivery and connection of the caller to the requested number. For example, the SMS message may contain the information “John Doe, 206-555-1212” embedded in an SMS message confirmation of the inquiry.

While useful, the subscriber then manually enters the information from the received SMS message into the local directory of their mobile handset. The subscriber does this after the 411 call has ended or not at all, if the subscriber forgets due to an unforeseen interruption.

### SUMMARY OF THE INVENTION

The present invention provides a client application on a mobile handset that identifies short message service (SMS) messages in a 411 format and extracts the caller identification information in the SMS message. The client application presents a query on the display or keypad of the mobile handset that allows the subscriber to automatically enter the extracted caller identification information into the contacts or caller information directory on the mobile device.

The present invention directly supports the customer/subscriber and protects the revenue generated by 411 queries with a carrier-enhanced service. This is valuable in that traditional 411 service using directory assistance (DA) is threatened by data service providers that provide reverse directory lookup applications using the Internet or other database channels on the mobile network.

### BRIEF DESCRIPTION OF THE DRAWINGS

Preferred and alternative examples of the present invention are described in detail below with reference to the following drawings:

FIG. 1 is a schematic diagram of a mobile system with a mobile handset configured in accordance with an embodiment of the present invention;

FIG. 2 is a block diagram of an example mobile handset formed in accordance with an embodiment of the present invention; and

FIG. 3 is a flowchart of an example process performed by the handset shown in FIGS. 1 and 2.

### DETAILED DESCRIPTION OF THE PREFERRED EMBODIMENT

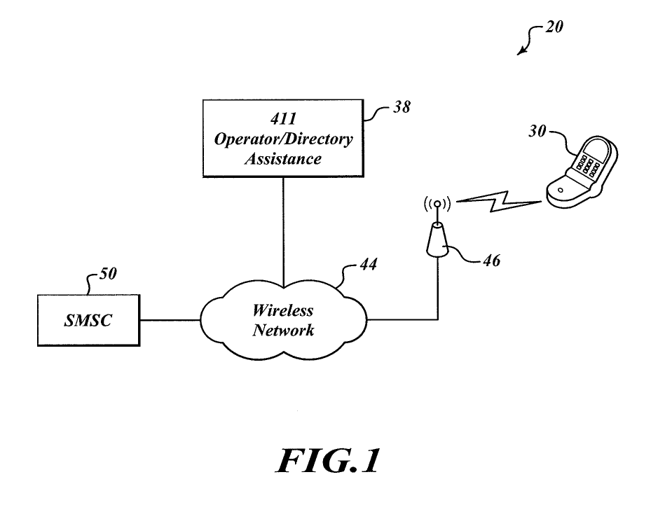

FIG. 1 illustrates a wireless/cellular system 20 that includes one of many mobile handsets 30, one of a plurality of wireless/cellular nodes (also known as Mobile Switching Centers (MSCs)) 46, a wireless network 44, a 411 operator or Directory Assistance system (DA) 38, and a Short Message Service Center (SMSC) 50. The handset 30 includes a client application that automatically determines if an incoming short message service (SMS) message is a DA SMS message, then prompts the user of the handset 30 to determine whether the information included in the SMS message is to be stored locally on the handset 30.

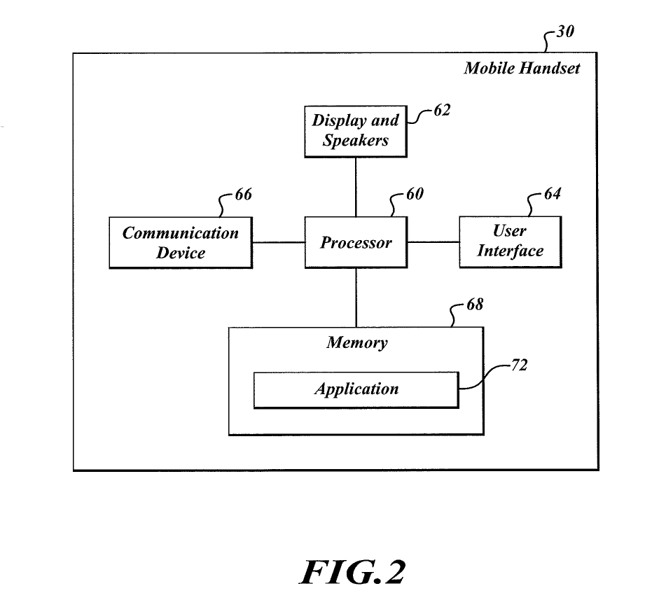

As shown in FIG. 2, an example of the mobile handset 30 includes a processor 60, output devices 62 (display(s) and/or speaker(s)), a user interface 64, a communication device 66, and memory 68. An application 72 is stored in the memory 68. When an SMS message is received the processor 60 runs the application 72, which determines if the SMS message was received from the DA 38 (i.e. formatted with DA included in the sender address information), then prompts the user of the handset 30 to determine if they want the information included in the SMS message stored locally on the handset 30. The mobile handset 30 may be a cell phone, mobile device, VoIP device, portable data assistant (PDA), or any comparable device.

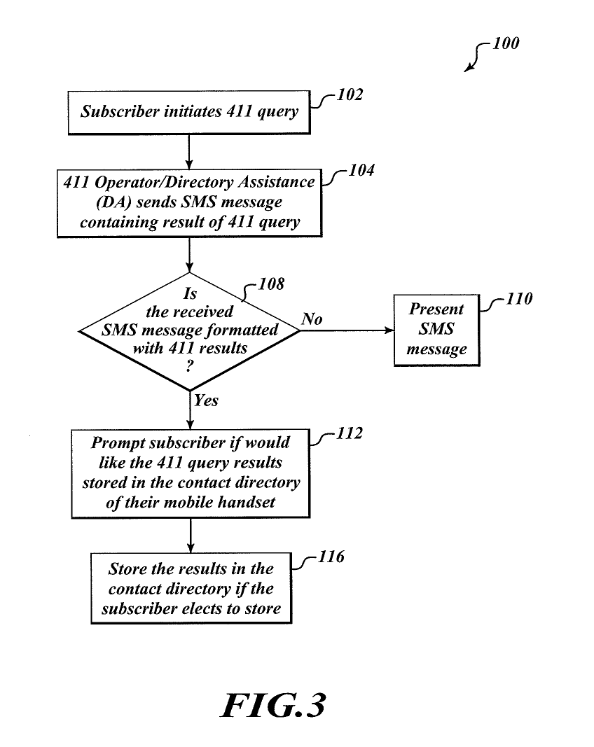

FIG. 3 shows an example process 100 performed by the handset 30. First at a block 102, a subscriber initiates a 411 query. Then at a block 104, the DA 38 answers the query by sending an SMS message containing the requested information to the mobile handset 30 of the subscriber via the SMSC 50. SMS message generation and delivery may be performed by a DA operator or automatically by an Interactive Voice Recognition (IVR) system that is included in the DA 38, or comparable system. Next at a decision block 108, the processor 60 running the application 72 analyzes the SMS message to determine if it is formatted as a response to a 411 query. The analysis of the SMS message preferably includes evaluation of a numerical code or message content associated with the SMS message. If the SMS message is determined not to be formatted with 411 query information, at a block 110 the SMS message is processed as a standard SMS message.

If the SMS message is determined to be formatted with 411 query information, then, at a block 112, the processor 60 prompts the subscriber to determine if they wish to store the information included in the SMS message in the caller directory of the handset 30. If the subscriber elects to store the information in the caller directory, at block 116 the processor 60 stores the information included in the SMS message. If the subscriber elects not to store the information in the caller directory, the process terminates.

In another embodiment, the processor 60 automatically extracts and stores the information included in the SMS message in the mobile handset's caller directory. This automatic placement into the caller directory may be done after the processor 60 determines the information included in the SMS message was not previously stored in the caller directory.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method comprising:
receiving at a mobile device a message associated with a 411 event;
automatically extracting identification information from the received message; and
storing the extracted identification information in a caller directory of the mobile device.

2. The method of claim 1, wherein storing comprises storing the extracted identification information in the caller directory based on a user response.

3. The method of claim 2, wherein storing the extracted identification information in the caller directory based on a user response comprises:
presenting a query on the mobile device, the query comprises a user interface prompt;
receiving a response to the presented prompt; and
storing based on the received response.

4. The method of claim 1, wherein storing comprises:
determining if the extracted identification information is already stored in the caller directory; and
automatically storing the extracted identification information in the caller directory if it was determined that the extracted identification information is not already stored in the caller directory.

5. The method of claim 1, wherein the received message is a short message service (SMS) message sent from a 411 operator system.

6. The method of claim 1, wherein the identification information comprises at least one of name, business name, address, city, state, country or phone number.

7. The method of claim 1, wherein automatically extracting comprises identifying the received message as being a 411 formatted message and extracting the identification information based on predefined rules associated with identification of 411 formatted messages.

8. A system comprising:
a means for receiving at a mobile device a message associated with a 411 event;
a means for automatically extracting identification information from the received message; and
a means for storing the extracted identification information in a caller directory of the mobile device.

9. The system of claim 8, wherein the means for storing stores the extracted identification information in the caller directory based on a user response.

10. The system of claim 8, wherein the means for storing presents a query on the mobile device consisting of a user interface prompt, receives a response to the presented prompt, and stores based on the received response.

11. The system of claim 8, wherein the means for storing determines if the extracted identification information is already stored in the caller directory and automatically stores the extracted identification information in the caller directory if it was determined that the extracted identification information is not already stored in the caller directory.

12. The system of claim 8, wherein the received message is a short message service (SMS) message sent from a 411 operator system.

13. The system of claim 8, wherein the identification information comprises at least one of name, business name, address, city, state, country or phone number.

14. The system of claim 8, wherein the means for automatically extracting identifies the received message as being a 411 formatted message and extracts the identification information based on predefined rules associated with identification of 411 formatted messages.

15. A mobile communication device comprising:
a communication component configured to receive a message associated with a 411 event;
a user interface;
memory; and
a processor in communication with the communication component, the user interface and the memory, the processor configured to automatically extract identification information from the received message and store the extracted identification information in a caller directory in the memory of the mobile device.

16. The device of claim 15, wherein the processor stores the extracted identification information in the caller directory based on a user response.

17. The device of claim 15, wherein the processor presents a query on the user interface, receives a response to the presented query and stores the extracted identification information in a caller directory in the memory of the mobile device based on the received response.

18. The device of claim 15, wherein the processor determines if the extracted identification information is already stored in the caller directory and automatically stores the extracted identification information in the caller directory if it was determined that the extracted identification information is not already stored in the caller directory.

19. The device of claim 15, wherein the received message is a short message service (SMS) message sent from a 411 operator system.

20. The device of claim 15, wherein the identification information comprises at least one of name, business name, address, city, state, country or phone number.

21. The device of claim 15, wherein the processor identifies the received message as being a 411 formatted message and extracts the identification information based on predefined rules associated with identification of 411 formatted messages.
